(19) United States
(12) Patent Application Publication
(10) Pub. No.: US 2019/0288612 A1
(43) Pub. Date: Sep. 19, 2019

(54) MOTOR DRIVE DEVICE

(71) Applicants: KABUSHIKI KAISHA TOSHIBA, Tokyo (JP); TOSHIBA ELECTRONIC DEVICES & STORAGE CORPORATION, Tokyo (JP)

(72) Inventor: Masahiro KATO, Yokohama Kanagawa (JP)

(73) Assignees: KABUSHIKI KAISHA TOSHIBA, Tokyo (JP); TOSHIBA ELECTRONIC DEVICES & STORAGE CORPORATION, Tokyo (JP)

(21) Appl. No.: 16/112,127

(22) Filed: Aug. 24, 2018

(30) Foreign Application Priority Data
Mar. 14, 2018 (JP) 2018-047068

(51) Int. Cl. H02M 7/5387; H02P 27/08

(52) U.S. Cl. CPC H02M 7/53875; H02P 27/08

(57) ABSTRACT

A motor drive device has an output transistor that outputs a motor current. It has a drive circuit that supplies a drive signal to the output transistor. It has a detection transistor that is connected in parallel to the output transistor and outputs a current that is proportional to a current that flows through the output transistor. It has a control circuit that adjusts timing when the drive circuit supplies the drive signal, depending on a phase of an induced voltage of a motor and a phase of a current that is output by the detection transistor.

### CROSS-REFERENCE TO RELATED APPLICATION(S)

This application is based upon and claims the benefit of priority from Japanese Patent Application No. 2018-47068, filed on Mar. 14, 2018; the entire contents of which are incorporated herein by reference.

### FIELD

The present embodiment generally relates to a motor drive device.

### BACKGROUND

For a motor drive device, it is important to match phases of an induced voltage and a motor current in order to improve efficiency of a motor. A phase of a motor current is retarded with respect to an induced voltage due to an influence of an inductance component of an exciting coil of a motor, with increasing a rotational speed of the motor. Hence, control to advance a phase of an applied voltage for a motor, that is, a technique of advanced angle control is disclosed.

An attempt to execute control to advance a phase of an applied voltage for a motor within a preset range has been executed conventionally, where a phase difference between an induced voltage and a motor current is changed depending on a rotational speed of the motor. Therefore, a configuration is desired that is capable of controlling an amount of an advanced angle appropriately, depending on an operating state of a motor.

### BRIEF DESCRIPTION OF THE DRAWINGS

FIG. 1 is a diagram illustrating a configuration of a motor drive device according to a first embodiment.

FIG. 2 is a diagram for explaining control of a motor drive device according to the first embodiment.

FIG. 3 is a diagram illustrating an example of a configuration of arrangement of a rotor position detector.

FIG. 4 is a diagram illustrating a configuration of a motor drive device according to a second embodiment.

FIG. 5A and FIG. 5B are diagrams illustrating one embodiment where an output transistor and a detection transistor are integrated.

### DETAILED DESCRIPTION

According to the present embodiment, a motor drive device has an output transistor that outputs a motor current. It has a drive circuit that supplies a drive signal to the output transistor. It has a detection transistor that detects a current that is proportional to a current that flows through the output transistor where its corresponding main electrode and control electrode are commonly connected to one main electrode and a control electrode of the output transistor, respectively. It has a detection unit that outputs a phase signal that indicates a phase of an induced voltage of a motor. It has a control circuit that adjusts timing when the drive circuit supplies the drive signal, depending on a phase of a current that is output by the detection transistor and a phase of a phase signal that is output by the detection means.

Hereinafter, a motor drive device according to an embodiment will be explained in detail with reference to the accompanying drawings. Additionally, the present invention is not limited by such an embodiment.

### First Embodiment

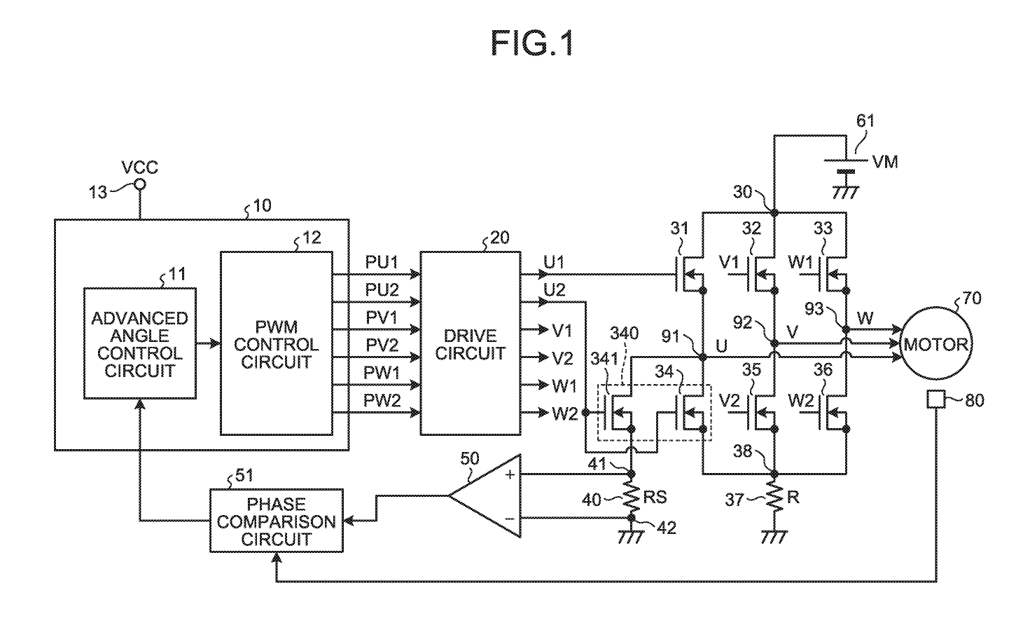

FIG. 1 is a diagram illustrating a configuration of a motor drive device according to a first embodiment. The present embodiment has NMOS output transistors 31-36 that supply drive currents to (non-illustrated) exciting coils for respective phases of a motor 70. A source of the output transistor 31 is connected to an output terminal 91 and its drain is connected to a voltage supply terminal 30. That is, a source-drain path that is a main current path of the output transistor 31 is connected between the voltage supply terminal 30 and the output terminal 91. A voltage source 61 that supplies a voltage VM is connected to the voltage supply terminal 30.

A drive signal U1 is supplied from a drive circuit 20 to a gate of the output transistor 31. The output transistor 31 turns on in response to the drive signal U1 and supplies a drive current to an (non-illustrated) exciting coil for U-phase that is connected to the output terminal 91.

Similarly, drains of the output transistors 32, 33 are each connected to the voltage supply terminal 30 and their sources are connected to output terminals 92, 93, respectively. Gates of the output transistors 32, 33 are supplied with drive signals V1, W1 from the drive circuit 20.

A drain of the output transistor 34 is connected to the output terminal 91 and its source is connected to a common connection terminal 38. Similarly, drains of the output transistors 35, 36 are connected to the output terminals 92, 93, respectively, and their sources are connected to the common connection terminal 38.

A gate of the output transistor 34 is supplied with a drive signal U2 from the drive circuit 20. The output transistor 34 turns on in response to the drive signal U2 and outputs a motor current from the exciting coil for U-phase.

Similarly, a gate of the output transistor 35 is supplied with a drive signal V2 from the drive circuit 20 and a gate of the output transistor 36 is supplied with a drive signal W2.

The respective output transistors 31-36 turn on during a period of time for an electrical angle of 180 degrees in response to the drive signals U1, U2, V1, V2, W1, W2 and execute sinusoidal driving for supplying a sinusoidal drive current to the motor 70.

One terminal of a resistor 37 with a resistance value R is connected to the common connection terminal 38 and the other terminal of the resistor 37 is grounded.

An NMOS detection transistor 341 is connected to the output transistor 34. A drain of the detection transistor 341 is connected to a drain of the output transistor 34 and its source is connected to a detection terminal 41. The detection terminal 41 is connected to one terminal of a detection resistor 40 with a resistance value RS. The other terminal of the detection resistor 40 is connected to a grounding terminal 42. A gate of the detection transistor 341 is supplied with the drive signal U2.

The output transistor 34 and the detection transistor 341 are integrated and formed on an (non-illustrated) identical semiconductor substrate. They are formed on an identical semiconductor substrate so that it is possible to match characteristics of the output transistor 34 and the detection transistor 341. For example, a dimension of the detection transistor 341 is reduced at a dimension rate of 1/N (where N is an arbitrary positive number that is greater than 1) with respect to that of the output transistor 34. Thereby, it is possible to provide a configuration in such a manner that a current that is proportional to a drain current of the output transistor 34, that is, a current that is 1/N times the drain current of the output transistor 34 flows through the detection transistor 341.

A dimension of the detection transistor 341 is 1/N times that of the output transistor 34 and drains of the output transistor 34 and the detection transistors 341 that are one of main electrodes thereof and their gates that are a control electrode thereof are commonly connected respectively. Thereby, it is possible for the detection transistor 341 to detect a current that is 1/N times a current that flows through the output transistor 34.

It is also possible to configure the output transistor 34 and the detection transistors 341 as (non-illustrated) a discrete semiconductor chip. They are formed as a discrete semiconductor chip so that it is possible to use them as dedicated semiconductor chip that detects a current that is 1/N times a motor current.

A comparison circuit 50 detects a voltage drop that is caused by a drain current of the detection transistor 341 at the detection resistor 40. A non-inverting input terminal (+) of the comparison circuit 50 is connected to the detection terminal 41 and its inverting input terminal (−) is connected to the grounding terminal 42. When an electric potential of the detection terminal 41 is higher than that of the grounding terminal 42, the comparison circuit 50 outputs a positive output signal.

The present embodiment has a rotor position detector 80 that detects a position of a rotor of a motor. The rotor position detector 80 is composed of, for example, a Hall element.

Due to rotation of the motor 70, a magnet for an S-pole and a magnet for an N-pole of a rotor (where both of them are not illustrated) alternately approaches an exciting coil for each phase, and a magnetic flux in such an exciting coil is changed therewith, so that an induced voltage is generated at each exiting coil.

Therefore, due to an output of a Hall element, it is possible to detect positions of magnets for an N-pole and an S-pole of a rotor of the motor 70 (a position of such a rotor) and simultaneously detect a phase of an induced voltage. An output of a Hall element that is arranged in a direction of rotation of the motor 70 is detected so that it is possible to execute detection of a position of a rotor of the motor 70 and a phase of an induced voltage.

Output signals (phase signals) of the comparison circuit 50 and the rotor position detector 80 are supplied to a phase comparison circuit 51. The phase comparison circuit 51 compares phases of output signals of the comparison circuit 50 and the rotor position detector 80 and outputs a signal dependent on a result of such comparison.

An output signal of the comparison circuit 50 is changed depending on a current that flows through the detection resistor 40. A current that flows through the detection resistor 40 is changed depending on a drain current of the output transistor 34, that is, is changed depending on a drain current of the detection transistor 341 that is proportional to a motor current. Therefore, due to a change of an output signal of the comparison circuit 50, it is possible to detect a phase of a motor current.

On the other hand, the rotor position detector 80 outputs a signal that indicates a phase of an induced voltage. Therefore, due to output signals of the comparison circuit 50 and the rotor position detector 80, it is possible to detect a phase of a motor current and a phase of an induced voltage.

Timings of changes of output signals of the comparison circuit 50 and the rotor position detector 80 are compared and control is executed so as to match both timings of changes, so that it is possible to execute control to cause a phase of an induced voltage to coincide with a phase of a motor current.

The phase comparison circuit 51 compares phases of output signals of the comparison circuit 50 and the rotor position detector 80 and supplies a signal dependent on a result of such comparison to an advanced angle control circuit 11. A control circuit 10 operates with a power supply voltage VCC that is supplied to a terminal 13.

The advanced angle control circuit 11 supplies a control signal dependent on an output signal of the phase comparison circuit 51 to a PWM control circuit 12. In a case where a retardation of a phase of a motor current that is indicated by an output of the comparison circuit 50 with respect to a phase of an induced voltage that is indicated by an output signal of the rotor position detector 80 is detected, the PWM control circuit 12 executes control to advance timing when PWM signals PU1, PU2, PV1, PV2, PW1, PW2 that are supplied to the drive circuit 20 are output. The control circuit 10 is composed of the advanced angle control circuit 11 and the PWM control circuit 12.

The drive circuit 20 amplifies the PWM signals PU1, PU2, PV1, PV2, PW1, PW2 to output the drive signals U1, U2, V1, V2, W1, W2. Timings of the PWM signals PU1, PU2, PV1, PV2, PW1, PW2 are advanced, so that timings of the drive signals U1, U2, V1, V2, W1, W2 that are supplied to the respective output transistors 31-36 are advanced.

Timings of the drive signals U1, U2, V1, V2, W1, W2 are advanced so that timings of turning on/off of the output transistors 31-36 are advanced. Thereby, it is possible to advance a phase of an applied voltage that is applied to the motor 70. Due to a series of such control, it is possible to advance timing when a drive current is supplied to an exciting coil, and hence, it is possible to advance a phase of a motor current.

That is, in a case where a phase of a motor current is retarded, control to advance a phase of an applied voltage and advance such a phase of a motor current is executed, so that it is possible to execute control to match phases of an induced voltage and a motor current. Thereby, it is possible to improve efficiency of the motor 70.

In the present embodiment, a current of the output transistor 34 that outputs a motor current is constantly monitored by the detection transistor 341 so that it is possible to appropriately execute advanced angle control depending on a state of such a motor current. That is, it is possible to appropriately cause advanced angle control to reflect a phase retardation of a motor current that is changed depending on a change of a rotational speed of the motor 70.

A state of a motor current that flows through the output transistor 34 is detected by the detection transistor 341 with a small size that is reduced at a predetermined dimension rate of 1/N with respect to that of the output transistor 34. Therefore, an increase in power consumption that is caused by providing the detection transistor 341 is suppressed. That is, an increase in power consumption is suppressed, so that it is possible to provide a configuration that detects a current of the output transistor 34, that is, a state of a motor current.

Furthermore, the output transistor and the detection transistor 341 are configured to be formed on an identical semiconductor chip, so that it is possible to match characteristics of the output transistor 34 and the detection transistor 341, and hence, it is possible to accurately detect a motor current due to a drain current of the detection transistor 341.

That is, a dimension of the detection transistor 341 is reduced at a predetermined dimension rate of 1/N with respect to that of the output transistor 34, so that it is possible to accurately detect a current that is 1/N times a drain current of the output transistor 34 due to a drain current of the detection transistor 341.

A power supply voltage VCC that is applied to the control circuit 10 is, for example, approximately 15V whereas a voltage VM at the voltage supply terminal 30 is, for example, a high voltage of approximately 240V. Hence, a high-voltage-resistant element is desired for the output transistors 31-36. A structure 340 where the output transistor 34 that is high-voltage-resistant and the detection transistor 341 are integrated therein is provided as a discrete semiconductor chip, and thereby, is readily applied to a motor drive device that detects a motor current accurately. Additionally, the MOS transistors 31, 32, 33 that supply a drive current may be composed of PMOS transistors. In a case where they are composed of PMOS transistors, polarities of the drive signals U1, V1, and W1 that control turning on/off are reversed to be supplied to gates of respective PMOS transistors.

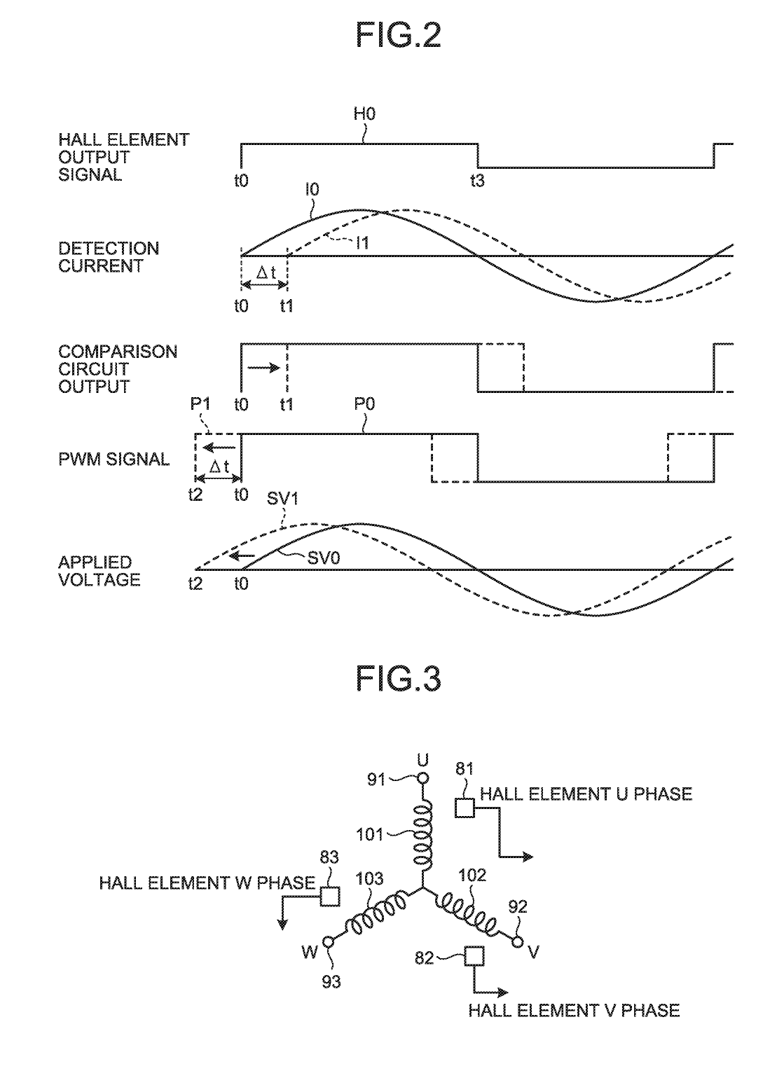

FIG. 2 is a diagram for explaining control of a motor drive device according to the first embodiment. A top line illustrates an output signal H0 from a Hall element. An output level of the output signal H0 is changed depending on a polarity of a permanent magnet of a rotor and an induced voltage of an exciting coil is also changed depending on such a polarity of a permanent magnet. Therefore, it is possible to use timings t0, t3 when a level of the output signal H0 is changed, as information that indicates a phase of an induced voltage.

A detection current that is illustrated at a second line from the top indicates a current that is detected by the detection transistor 341. That is, a current that is 1/N times a motor current that flows through the output transistor 34 is indicated. For example, as a phase retardation is caused for a motor current, a detection current is changed from a current waveform I0 that is a positive phase at the timing t0 to a current waveform I1 that is a positive phase at the timing t1 depending on such a phase retardation. That is, the current waveform I1 is provided that involves a phase retardation Δt that corresponds to a phase retardation of a motor current.

A third line from the top illustrates an output signal of the comparison circuit 50. A level of an output signal of the comparison circuit 50 is changed depending on a detection current. The comparison circuit 50 outputs a signal at an H level at a time when a detection current is positive or outputs a signal at an L level as such a detection current is negative. Therefore, timing when an output signal of the comparison circuit 50 is changed to an H level depending on a caused phase retardation Δt moves from t0 to t1. The phase comparison circuit 51 outputs a signal dependent on such a phase retardation Δt to the advanced angle control circuit 11.

A fourth line from the top illustrates an example of a PWM signal. In a case where a phase retardation Δt is caused, the advanced angle control circuit 11 supplies a control signal to the PWM control circuit 12 to advance timings when the PWM signals PU1, PU2, PV1, PV2, PW1, PW2 are output. That is, control is executed to advance an output of a PWM signal from timing t0 to t2 depending on a phase retardation Δt and advance from a signal that is indicated by a solid line P0 to a signal that is indicated by a broken line P1.

As timings of the PWM signals PU1, PU2, PV1, PV2, PW1, PW2 are advanced, timings when the drive circuit 20 amplifies the PWM signals PU1, PU2, PV1, PV2, PW1, PW2 and outputs the drive signals U1, U2, V1, V2, W1, W2 are advanced, and hence, timings of turning on/off of the output transistors 31-36 are advanced, so that it is possible to advance a phase of an applied voltage.

A bottom line illustrates an applied voltage that is applied to the motor 70. Timings of output of the PWM signals PU1, PU2, PV1, PV2, PW1, PW2 are advanced and timings when the drive signals U1, U2, V1, V2, W1, W2 are supplied are advanced, so that an applied voltage is shifted from a waveform that is indicated by a sold line SV0 to a waveform that is indicated by a broken line SV1. That is, timing when an applied voltage is applied is advanced from t0 to t2, and thereby, a phase of a motor current is advanced, so that it is possible to execute advanced angle control to match phases of an induced voltage and such a motor current.

FIG. 3 is a diagram illustrating an example of a configuration of arrangement of Hall elements 81-83 that are used as the rotor position detector 80. An example is illustrated where the Hall elements 81-83 are arranged to correspond to exciting coils 101-103 for respective phases that are connected to the output terminals 91-93. The Hall elements 81-83 are arranged in a direction of rotation of the motor 70 and their outputs are detected, so that it is possible to detect a position of a rotor of the motor 70 and a phase of an induced voltage.

in the first embodiment, it is possible to provide a configuration that supplies an output signal of, for example, the Hall element for U-phase 81, among the Hall elements 81-83, to the phase comparison circuit 51. Additionally, it is possible to provide a configuration that provides an (non-illustrated) amplifier that amplifies, and outputs to the phase comparison circuit 51, output signals of the Hall elements 81-83.

### Second Embodiment

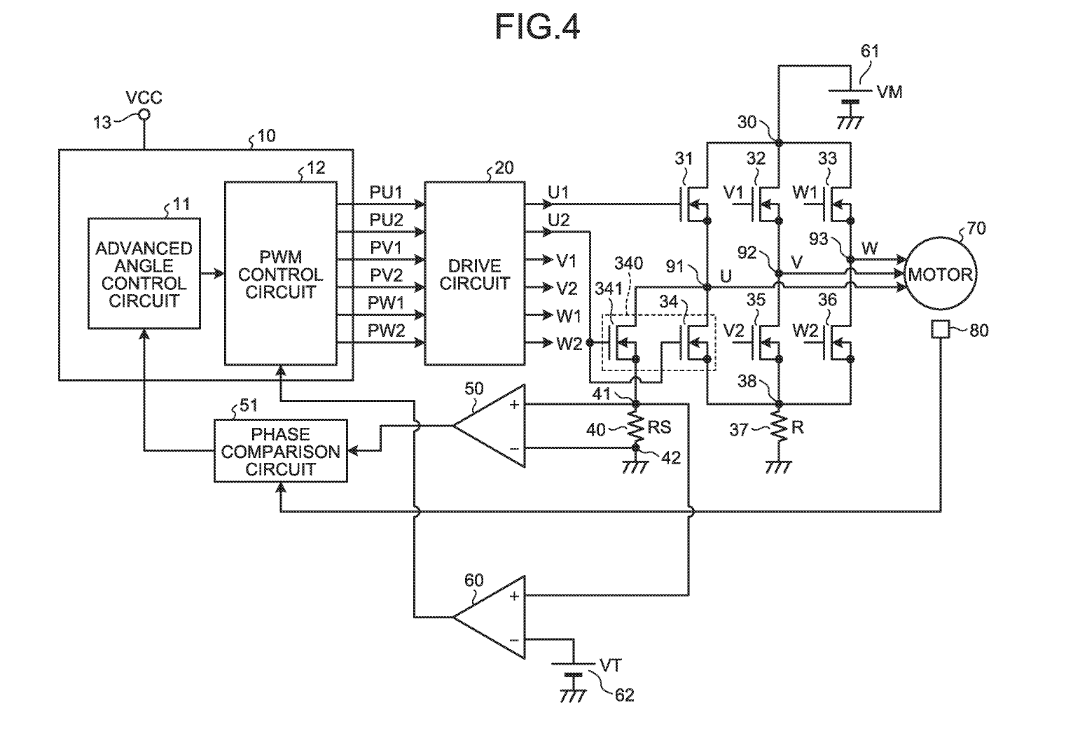

FIG. 4 is a diagram illustrating a configuration of a motor drive device according to a second embodiment. A component that corresponds to that of the embodiment as already described is provided with an identical sigh and a duplicative description is provided only in a case of need.

The present embodiment has a comparison circuit 60 where a non-inverting input terminal (+) is connected to the detection terminal 41 and an inverting input terminal (−) is connected to a power supply 62 that supplies a threshold voltage VT.

The comparison circuit 60 outputs an output signal at an H level when a voltage drop at the detection resistor 40 is higher than the threshold voltage VT. For example, in a case where a current that is proportional to an overcurrent that flows the output transistor 34 flows through the detection transistor 341, an output signal at an H level is output.

An output signal of the comparison circuit 60 is supplied to the PWM control circuit 12. For example, it is possible to stop an operation of the PWM control circuit 12 in response to an output signal at an H level from the comparison circuit 60. Supply of the PWM signals PU1, PU2, PV1, PV2, PW1, PW2 is stopped, and thereby, the drive signals U1, U2, V1, V2, W1, W2 are stopped, so that it is possible to turn off the output transistors 31-36 and stop supply of an electric power to the motor 70. Thereby, it is possible to protect the output transistors 31-36 and the motor 70 from overcurrent states thereof.

A current of the detection transistor 341 is detected so that it is possible to detect an abnormal state of a motor current. That is, a current of the detection transistor 341 is monitored, and thereby, it is possible to monitor a state of a motor current constantly, so that it is also possible to execute a protective operation from its overcurrent state in addition to advanced angle control.

Additionally, control to supply an output signal of the comparison circuit 60 to the drive circuit 20 and thereby stop an operation of the drive circuit 20 may be executed.

A configuration that provides the detection transistor 341 and the detection resistor 40 to the output transistor 34 is not limiting but may be a configuration they are also provided to the output transistors 35, 36. It is possible to provide a configuration that supplies a voltage drop that is caused at each detection resistor to a non-inverting terminal (+) of the comparison circuit 60. It is possible to detect abnormality of motor currents that flow through the respective exciting coils 101-103, and thereby, improve a function of overcurrent protection.

According to the present embodiment, a current that is proportional to a motor current of the output transistor 34 is detected by the detection transistor 341 and thereby it is possible to monitor such a motor current constantly, so that it is possible to appropriately execute advanced angle control to cause such a motor current to coincide with a phase of an induced voltage and a phase of.

Furthermore, a current of the detection transistor 341 is detected so that it is possible to detect an overcurrent state of a motor current. In a case where an overcurrent state is provided, supply of the drive signals U1, U2, V1, V2, W1, W2 is stopped and thereby it is possible to execute an overcurrent protection for the output transistors 31-36 and the motor 70. It is also possible to use an output current of the detection transistor 341 for overcurrent detection, so that it is possible to suppress an increase in power consumption for overcurrent protection.

Furthermore, the output transistor 34 and the detection transistor 341 are configured to be formed on an identical semiconductor chip so that it is possible to detect a state of a motor current accurately. It is possible to detect a state of a motor current accurately so that it is possible to provide a motor drive device that is capable of executing advanced angle control and a function of overcurrent protection appropriately.

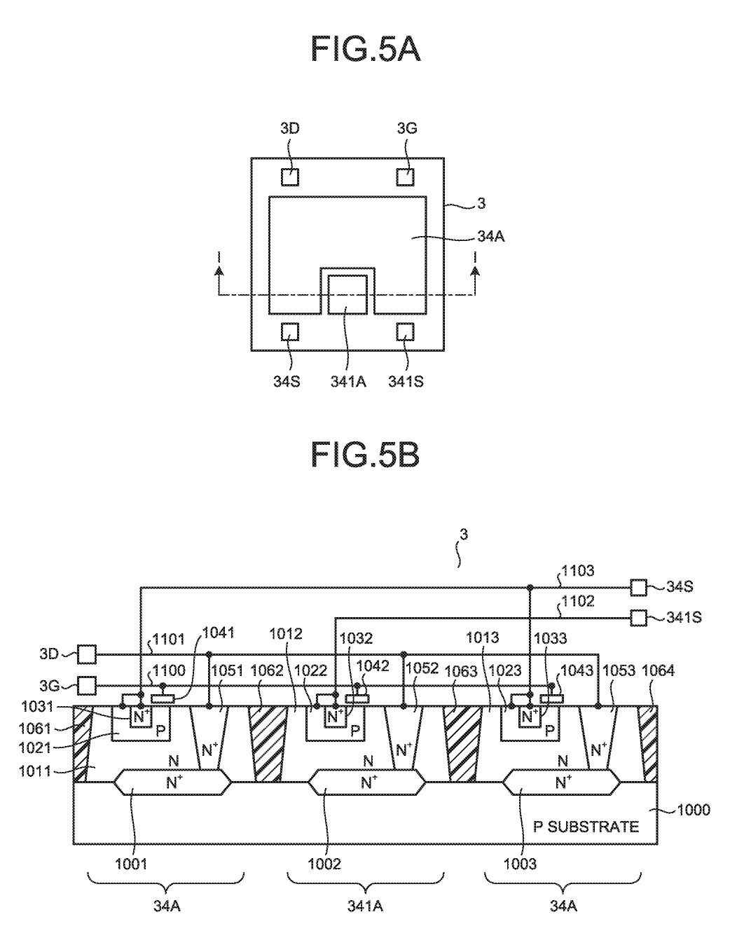

FIG. 5A and FIG. 5B illustrate one embodiment where the output transistor 34 and the detection transistor 341 are formed on a discrete semiconductor chip. FIG. 5A is a diagram illustrating a discrete semiconductor chip 3 in a planar manner. The output transistor 34 is formed in a region 34A of the semiconductor chip 3 and the detection transistor 341 is formed in a region 341A thereof.

The semiconductor chip 3 has four pads 3D, 3G, 34S, and 341S. The pad 3D is connected to a drain of the output transistor 34 and a drain of the detection transistor 341 and used as a pad for a common drain electrode. In the embodiment as already described, the pad 3D is connected to, for example, the output terminal 91. The pad 3G is connected to a gate of the output transistor 34 and a gate of the detection transistor 341 and used as a pad for a common gate electrode. In the embodiment as already described, the pad 3G receives, for example, supply of the drive signal U2 from the drive circuit 20. The pad 34S is connected to a source of the output transistor 34 and used as a pad for a source electrode of the output transistor 34. Furthermore, the pad 341S is connected to a source of the detection transistor 341 and used as a pad for a source electrode of the detection transistor 341. In the embodiment as already described, the pad 341S is connected to, for example, the detection terminal 41. in the embodiment as already described, the pad 341S is connected to, for example, the common connection terminal 38.

FIG. 5B is a diagram schematically illustrating a cross-sectional structure along a dashed-dotted line I-I of FIG. 5A. In the present embodiment, the output transistor 34 and the detection transistor 341 are composed of DMOS transistors. That is, a P-type region 1021 and an N-type region 1031 are formed in an N-type region 1011 on a P-type semiconductor substrate 1000 as illustrated on a left side by means of double diffusion so that an N-channel type DMOS transistor is configured in such a manner that its drain is the N-type region 1011, its source is the N-type region 1031, and its gate is an electrode 1041 that is formed on the P-type region 1021 via an (non-illustrated) insulation film. The N-type region 1011 is connected to the pad 3D via an N-type embedded region 1001, an N-type connection region 1051, and a wire 1101. The N-type region 1031 that composes a source and the P-type region 1021 are connected to the pad 34S via a wire 1103. The electrode 1041 is connected to the pad 3G by a wire 1100. Additionally, although a case where a plurality of structures of the N-type region 1031 and the P-type region 1021 that are formed by means of double diffusion are formed in the N-type region 1011 and respective corresponding regions are electrically connected in parallel by (non-illustrated) wires may be provided, one double diffusion region that has the N-type region 1031 and the P-type region 1021 is illustrated for sake of simplicity. Furthermore, a DMOS transistor is composed of the N-type region 1031, the P-type region 1021, and the N-type region 1011 that are formed by means of double diffusion, and hence, the number of double diffusion regions that have the N-type region 1031 and the P-type region 1021 is adjusted to execute parallel connection thereof so that it is possible to adjust the number of DMOS transistors that compose the output transistor 34.

Similarly, a P-type region 1023 and an N-type region 1033 are formed in an N-type region 1013 on the P-type semiconductor substrate 1000 as illustrated on a right side by means of double diffusion so that an N-channel type DMOS transistor is configured in such a manner that its drain is the N-type region 1013, its source is the N-type region 1033, and its gate is an electrode 1043 that is formed on the P-type region 1023 via an (non-illustrated) insulation film. The electrode 1043 is connected to the pad 3G by the wire 1100. The N-type region 1013 is connected to the pad 3D via an N-type embedded region 1003, an N-type connection region 1053, and the wire 1101. The N-type region 1033 and the P-type region 1023 are connected to the pad 345 via the wire 1103. Due to such a configuration, a DMOS transistor that is formed in the N-type region 1011 as illustrated on a left side and a DMOS transistor that is formed in the N-type region 1013 as illustrated on a right side are connected in parallel to configure an output MOS transistor 34 that includes a common source electrode 34S, a common drain electrode 3D, and a common gate electrode 3G. Additionally, although a case where a plurality of structures of the N-type region 1033 and the P-type region 1023 that are formed by means of double diffusion are formed in the N-type region 1013 and respective corresponding regions are electrically connected in parallel by (non-illustrated) wires may be provided, one double diffusion region that has the N-type region 1033 and the P-type region 1023 is illustrated for sake of simplicity. Furthermore, a DMOS transistor is composed of the N-type region 1033, the P-type region 1023, and the N-type region 1013 that are formed by means of double diffusion, and hence, the number of double diffusion regions that have the N-type region 1033 and the P-type region 1023 is adjusted to execute parallel connection thereof so that it is possible to adjust the number of DMOS transistors that compose the output transistor 34.

Similarly, a P-type region 1022 and an N-type region 1032 are formed in an N-type region 1012 on the P-type semiconductor substrate 1000 as illustrated on a center by means of double diffusion so that an N-channel type DMOS transistor is configured in such a manner that its drain is the N-type region 1012, its source is the N-type region 1032, and its gate is an electrode 1042 that is formed on the P-type region 1022 via an (non-illustrated) insulation film. The electrode 1042 is connected to the pad 3G by the wire 1100. The N-type region 1012 is connected to the pad 3D via an N-type embedded region 1002, an N-type connection region 1052, and the wire 1101. The N-type region 1032 and the P-type region 1022 are connected to the pad 3415 via a wire 1102. Due to such a configuration, the detection transistor 341 is configured that includes a source electrode 341S, a drain electrode 3D, and a gate electrode 3G. Additionally, although a case where a plurality of structures of the N-type region 1032 and the P-type region 1022 that are formed by means of double diffusion are formed in the N-type region 1012 and respective corresponding regions are electrically connected in parallel by (non-illustrated) wires may be provided, one double diffusion region that has the N-type region 1032 and the P-type region 1022 is illustrated for sake of simplicity. Furthermore, a DMOS transistor is composed of the N-type region 1032, the P-type region 1022, and the N-type region 1012 that are formed by means of double diffusion, and hence, the number of double diffusion regions that have the N-type region 1032 and the P-type region 1022 is adjusted to execute parallel connection thereof so that it is possible to adjust the number of DMOS transistors that compose the detection transistor 341. The N-type regions 1011, 1012, and 1013 are separated by isolation regions 1061, 1062, 1063, and 1064.

in the present embodiment, the output transistor 34 and the detection transistor 341 are integrally formed on the discrete semiconductor chip 3 that has the P-type semiconductor substrate 1000. The output transistor 34 and the detection transistor 341 are formed on the discrete semiconductor chip 3 that has an identical semiconductor substrate so that it is possible to match characteristics of the output transistor 34 and the detection transistor 341. Furthermore, for example, based on setting of the number of DMOS transistors that are formed in the region 34A and the region 341A and connected in parallel, it is possible to set a ratio of a drain current that flows through the detection transistor 341 to a drain current of the output transistor 34. For example, based on the number of double diffusion regions that have the P-type regions 1021, 1023 and the N-type regions 1031, 1033 that are formed in the region 34A by means of double diffusion and electrically connected in parallel and the number of double diffusion regions that have the P-type region 1022 and the N-type region 1032 that are formed in the region 341A by means of double diffusion and electrically connected in parallel, it is possible to set the number of DMOS transistors that are connected in parallel and compose the output transistor 34 and the number of DMOS transistors that are connected in parallel and compose the detection transistor 341, respectively. Hence, a ratio of such numbers is set at N to 1 so that it is possible to provide a configuration in such a manner that a current that is 1/N times a drain current of the output transistor 34 flows through the detection transistor 341. Furthermore, the semiconductor chip 3 includes the common drain electrode 3D, the common gate electrode 3G, and the respective source electrodes 34S, 341S, and hence, is capable of being used as the dedicated semiconductor chip 3 that detects, from the source electrode 341, a current that is 1/N times a motor current that is output from the source electrode 34S.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A motor drive device, comprising:
an output transistor that includes a first main electrode, a second main electrode, and a first control electrode and outputs a motor current;
a drive circuit that supplies a drive signal to the first control electrode;
a detection transistor that includes a third main electrode, a fourth main electrode, and a second control electrode, the third main electrode being connected to the first main electrode, the second control electrode being connected to the first control electrode, and outputs, from the fourth main electrode, a current that is proportional to a current that flows through the output transistor;
a detection unit that outputs a phase signal that indicates a phase of an induced voltage of a motor; and
a control circuit that adjusts timing when the drive circuit supplies the drive signal, depending on a phase of a current that is output by the detection transistor and a phase of the phase signal.

2. The motor drive device according to claim 1, wherein the output transistor and the detection transistor are composed of identical conductivity type MOS transistors and the detection transistor has a dimension that is reduced at a predetermined rate with respect to that of the output transistor.

3. The motor drive device according to claim 1, wherein the output transistor and the detection transistor are composed of identical conductivity type DMOS transistors and a number of a double diffusion region of a DMOS transistor that composes the detection transistor has a number that is reduced at a predetermined rate with respect to a number of a double diffusion region of a DMOS transistor that composes the output transistor.

4. The motor drive device according to claim 1, comprising:
a resistor that is connected in series with a main current path of the detection transistor; and
a detection circuit that outputs a signal dependent on a voltage drop that is caused at the resistor by a current that flows through the detection transistor, wherein the phase of the current that is output by the detection transistor is detected by an output of the detection circuit.

5. The motor drive device according to claim 4, comprising a comparison circuit that compares the voltage drop that is caused at the resistor with a predetermined reference voltage, and in a case where the voltage drop exceeds the predetermined reference voltage, outputs a signal that stops supply of the drive signal.

6. The motor drive device according to claim 1, wherein the output transistor and the detection transistor are formed on an integrated discrete semiconductor chip.

7. The motor drive device according to claim 6, wherein the discrete semiconductor chip includes:
a first pad that is commonly connected to the first main electrode and the third main electrode;
a second pad that is commonly connected to the first control electrode and the second control electrode;
a third pad that is connected to the second main electrode; and
a fourth pad that is connected to the fourth main electrode.

8. The motor drive device according to claim 1, wherein the detection unit includes a Hall element.

9. The motor drive device according to claim 1, wherein the control circuit adjusts timing when the drive circuit supplies the drive signal, in such a manner that the phase of the current that is output by the detection transistor coincides with the phase of the induced voltage.

10. The motor drive device according to claim 1, wherein the output transistor and the detection transistor are integrated and formed on an identical semiconductor substrate.

11. The motor drive device according to claim 1, wherein a first power supply voltage is applied to the control circuit and a second power supply voltage that is higher than the first power supply voltage is applied to the output transistor.

12. A motor drive device, comprising:
an output transistor that includes a first main electrode, a second main electrode, and a first control electrode and outputs a motor current;
a drive circuit that supplies a drive signal to the first control electrode;
a detection transistor that includes a third main electrode, a fourth main electrode, and a second control electrode, the third main electrode being connected to the first main electrode, and outputs a current that is proportional to a current that flows through the output transistor;
a detection unit that outputs a phase signal that indicates a phase of an induced voltage of a motor;
a detection circuit that detects a phase of the current that is output by the detection transistor;
a comparison circuit that compares an output signal of the detection circuit with the phase signal that is output by the detection unit; and
a control circuit that responds to an output signal of the comparison circuit and adjusts timing when the drive circuit supplies the drive signal, in such a manner that the phase of the current coincides with the phase of the induced voltage.

13. The motor drive device according to claim 12, wherein the output transistor and the detection transistor are composed of identical conductivity type MOS transistors and the detection transistor has a dimension that is reduced at a predetermined rate with respect to that of the output transistor.

14. The motor drive device according to claim 12, wherein the output transistor and the detection transistor are composed of identical conductivity type DMOS transistors and a number of a double diffusion region of a DMOS transistor that composes the detection transistor has a number that is reduced at a predetermined rate with respect to a number of a double diffusion region of a DMOS transistor that composes the output transistor.

15. The motor drive device according to claim 13, wherein the output transistor and the detection transistor are composed of N channel type MOS transistors.

16. The motor drive device according to claim 12, wherein the output transistor and the detection transistor are formed on an integrated discrete semiconductor chip.

17. The motor drive device according to claim 16, wherein the discrete semiconductor chip includes:
a first pad that is commonly connected to the first main electrode and the third main electrode;
a second pad that is commonly connected to the first control electrode and the second control electrode;
a third pad that is connected to the second main electrode; and
a fourth pad that is connected to the fourth main electrode.

18. The motor drive device according to claim 14, comprising a resistor that is connected in series with a main current path of the detection transistor, wherein the detection circuit outputs a signal dependent on a voltage drop that is caused at the resistor.

19. The motor drive device according to claim 18, comprising a comparison circuit that compares the voltage drop that is caused at the resistor with a predetermined reference voltage, and in a case where the voltage drop exceeds the predetermined reference voltage, outputs a signal that stops supply of the drive signal.

20. The motor drive device according to claim 12, wherein a first power supply voltage is applied to the control circuit and a second power supply voltage that is higher than the first power supply voltage is applied to the output transistor.
